(19) United States
(12) Patent Application Publication
(10) Pub. No.: US 2013/0014352 A1
(43) Pub. Date: Jan. 17, 2013

(54) Repair Clip for Flexible Hold-down Straps

(71) Applicant: Bryan Alan Wells, Edon, OH (US)

(72) Inventor: Bryan Alan Wells, Edon, OH (US)

(21) Appl. No.: 13/183,588

(22) Filed: Jul. 15, 2011

(51) Int. Cl. F16B 45/00

(52) U.S. Cl. 24/265 H

(57) ABSTRACT

A device for repairing a broken elastic hold-down strap, shortening an elastic hold-down strap, or providing a third connection point therefore.

### BACKGROUND OF THE INVENTION

The present invention relates to elastic rubber hold-down straps commonly used to secure tarpaulins. These straps are usually supplied with an “s” shaped hook on the end enabling the strap to be secured to a grommet in the tarpaulin, and to a ring or a lip on the truck or trailer carrying the load. The ends of these straps will fail after time due to the stress imposed upon the strap by the hook. The hook will usually tear or fracture the end of the strap so there is no way for the broken end of the strap to be used. Generally, the solution to this problem is to throw the strap away and get a new one, even thought the rest of the strap may still be serviceable. The present invention provides a way to easily and securely fix the strap so that it may continue to be used. The present invention also can be used to add a hook to a strap so that it may be secured at three point rather than two. The present invention can further be used to shorten a strap that is too long.

### SUMMARY OF THE INVENTION

The present invention provides a device that repairs a broken rubber hold-down strap by capturing and securing the body of the strap with a metal clip that also provides a hook so the strap may be secured to a tarp or other like thing. In addition, the present invention may be used to provide a third point of attachment on a strap, or to shorten a strap that is too long for the job.

### BRIEF DESCRIPTION OF THE SEVERAL DRAWINGS

FIG. 1 is a perspective view of the invention.

FIG. 2 is a top view of the invention at a slight angle to the left and above center.

FIG. 3 is a top view of the invention with no angular offset.

FIG. 4 is a side view of the invention showing its use for repair of a broken strap.

FIG. 5 is a side view of the invention showing its use as a third connection point on a strap.

### DETAILED DESCRIPTION OF THE INVENTION

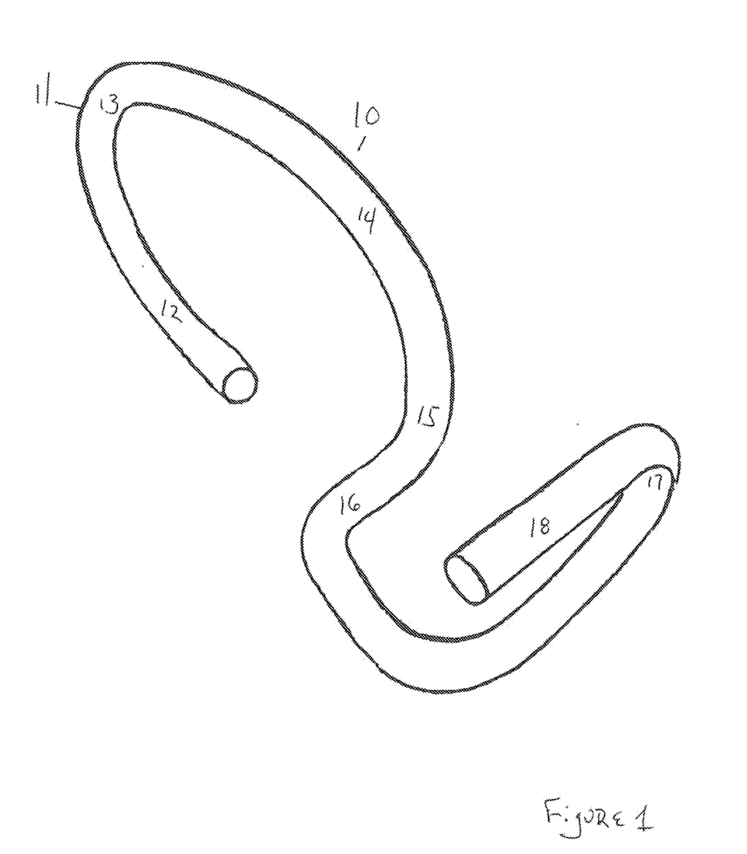

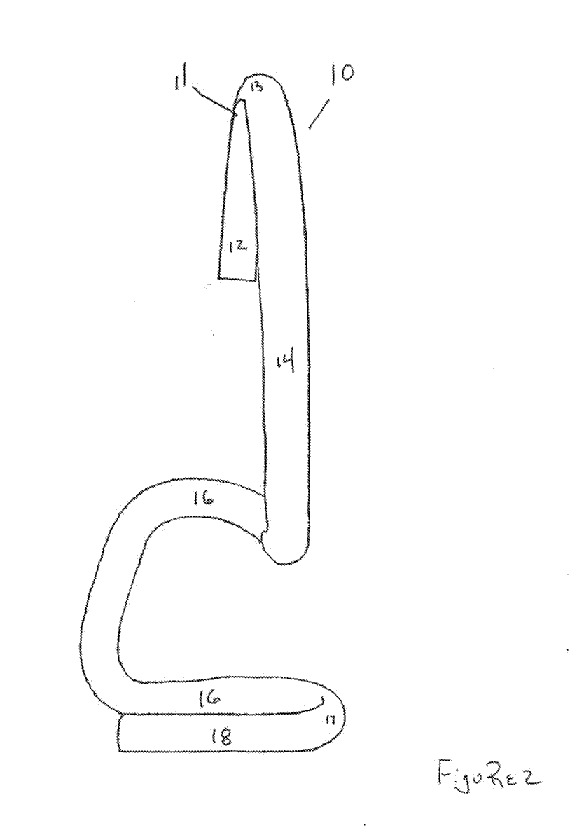

Referring to FIGS. 1 and 2, the device 10 can be seen with its constituent parts. In a preferred embodiment, the device 10 constructed from a single piece of steel wire with a diameter of about 3/16 of an inch. Steel wire is used in the preferred embodiment because it provides the necessary strength and rigidity to perform its function without deforming. Other materials and thickness of materials is anticipated. The device 10 has a first section 11 in the shape of a hook, having on the top a bow section 13 curved through approximately 180 degrees, and an elongated shank 14 extending from one end of the bow section 13, the shank 14 and bow 13 lying in the same plane. The shank 14 is contiguous with a center section 15 which also lies in the same plane as bow 13, the center section 15 extending perpendicularly from the shank 14 toward the opposite end of the bow 13. The length of the center section 15 is determined by the diameter of the bow 13, the center section 15 being long enough to extend the distance between shank 14 and the opposite side of the bow 13. The center section 15 is contiguous with a C-shaped transverse section 16. The shape of section 16 can be clearly seen by reference to FIG. 2. All of section 16 lies in one plane, that plane perpendicular center section 15. Section 16 is contiguous with a U-shaped section formed by the lower leg of section 16, an outwardly bent center portion section 17 and a straight leg portion 18 extending from section 17. Section 18 is parallel to section 16, the diameter of the bend in section 17 leaving a gap between the lower leg of section 16 and section 18. The size of the gap is determined by the size of the strap it is to be used on. The gap between section 18 and the lower leg of section 16 is just slightly larger than the thickness of the strap it is it be used with. Most hold down straps of the type pictured have a central thickness of 6.5 mm. The invention can be easily modified to accommodate straps of other thickness.

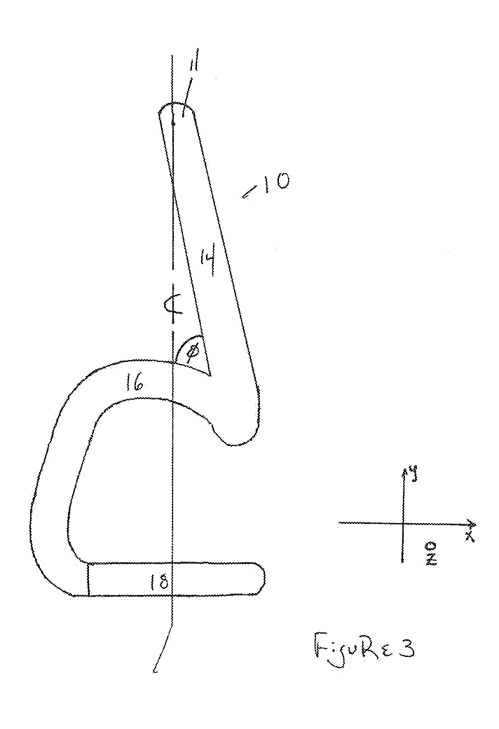

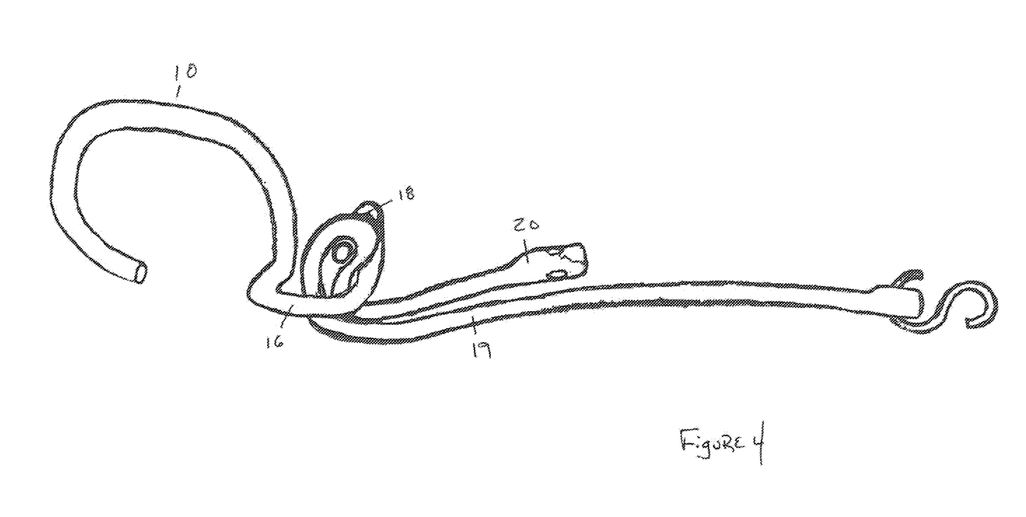

Referring to FIG. 4, the use of the invention for the repair of a broken strap 19 can be seen. The broken end 20 of the strap 19 must be placed between the strap 19 and the lower leg of section 16. The tension between hook 21 and hook 11 will keep the strap 19 locked into place, preventing it from slipping and allowing the strap to be continued to be used. The device 10 can also be used in this manner for shortening an unbroken strap. Referring to FIG. 3, the mechanics of the system can be seen. The hook section 11 of the device 10 is placed so that it is on the centerline of the strap 19. The hook section 11 is perpendicular to a plane formed by the lower leg of section 16 and section 18 on one axis of intersection, the z-axis as drawn, and offset at an inward angle φ on the other axis of intersection, the y-axis as drawn. The angle φ chosen so that the outward end of the hook 11 is at the centerline of the strap when the device is in use.

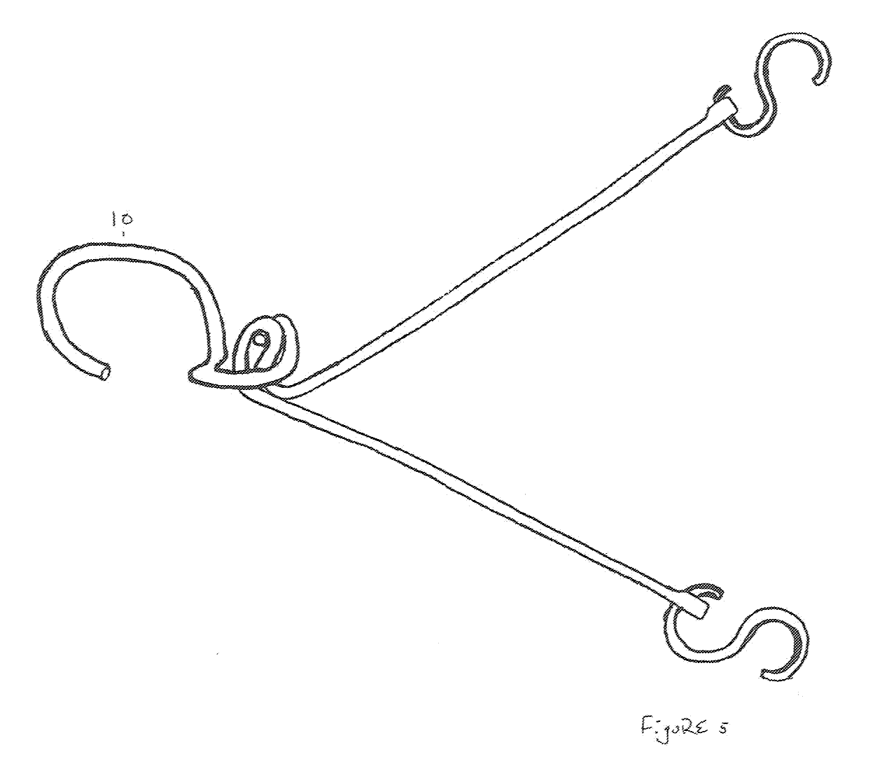

Referring now to FIG. 5, the device 10 can be seen as used for a third connection point.

The invention having been completely described, what is claimed is:

1. A device for repairing a broken elastic hold-down strap comprising: a first end in the shape of a hook, having a bow section curved through approximately 180 degrees, said bow section having a first end and a second end, a gap formed therebetween, an elongated shank extending from said second end of said bow section, said bow section and said shank lying in the same plane, a transverse member contiguous with and extending perpendicularly from said shank in the same plane as said bow across said gap, a C-shaped section having an upper portion contiguous with said transverse member and a straight lower section, said C-shaped section lying in a plane perpendicular to said transverse member, said lower section of said C-shaped section disposed away from said first end and forming an acute angle with the plane of said first end, a U-shaped second end lying in a plane perpendicular to said C-shaped section having a first leg formed by said lower section of said C-shaped section, a second leg parallel to said first leg, a curved portion joining said legs forming a gap therebetween, said second leg disposed toward said shank.

2. The device of claim 1 wherein said first and second legs of said second end are separated by a distance approximately equal to but not less than the thickness of a rubber hold-down strap.

3. The device of claim 1 wherein said acute angle formed with the plane of the first section and the lower section of said C-shaped section is sized so that a centerline of said bow section of said first end is forced to fall at a centerline of a hold-down strap when said strap is placed in said second end.

4. The device of claim 1 used to shorten an elastic hold-down strap.

5. The device of claim 1 used to provide a third connection point on an elastic hold-down strap.
